(19) United States
(12) Patent Application Publication
(10) Pub. No.: US 2021/0088139 A1
(43) Pub. Date: Mar. 25, 2021

(54) LAYER COMPOSITE FOR A SEAL, SEAL AND METHOD FOR MANUFACTURING A LAYER COMPOSITE

(71) Applicant: SGL CARBON SE, Wiesbaden (DE)

(72) Inventors: THOMAS KIRSCHBAUM, MEITINGEN (DE); LEA SCHUMANN, MEITINGEN (DE); RAINER ZEUSS, MEITINGEN (DE); MARTIN REINTHALER, MEITINGEN (DE)

(21) Appl. No.: 17/113,223

(22) Filed: Dec. 7, 2020

Related U.S. Application Data
(63) Continuation of application No. PCT/EP2019/064722, filed on Jun. 5, 2019.

(30) Foreign Application Priority Data
Jun. 6, 2018 (DE) 102018208967

(51) Int. Cl. F16J 15/10; B32B 9/04; B32B 37/10; F16J 15/3284

(52) U.S. Cl. CPC F16J 15/102; B32B 9/045; B32B 37/10; F16J 15/3284; B32B 2307/732; B32B 2581/00; B32B 2255/10; B32B 2250/02; B32B 2255/20; B32B 2307/546; B32B 2307/718

(57) ABSTRACT

A layer composite for a seal includes a planar substrate layer, e.g. a graphite foil layer, and a two-dimensionally contiguous polytetrafluoroethylene cover layer which adheres to a surface of the substrate layer. The polytetrafluoroethylene cover layer contains less than 200 g/m² of polytetrafluoroethylene. A seal and a method for manufacturing a layer composite are also provided.

### CROSS-REFERENCE TO RELATED APPLICATION

This application is a continuation, under 35 U.S.C. § 120, of copending International Application PCT/EP2019/064722, filed Jun. 5, 2019, which designated the United States; this application also claims the priority, under 35 U.S.C. § 119, of German Patent Application DE 10 2018 208 967, filed Jun. 6, 2018; the prior applications are herewith incorporated by reference in their entirety.

### BACKGROUND OF THE INVENTION

### Field of the Invention

The present invention relates to a layer composite for a seal, preferably for a gasket, that is suitable in particular for sealing flanges in the chemical industry, the petrochemical industry, in power plants and in the automotive industry, e.g. in industrial pipelines, in particular in chemical, oil and gas applications, and for thermal energy systems such as in an exhaust gas treatment system of a power plant or a motor vehicle. The invention also relates to a seal and a method for manufacturing a layer composite.

The use of polytetrafluoroethylene (PTFE), present in the form of particles, in conjunction with graphite is known.

For instance, Russian Utility Model RU 41 430 U1 describes a cylinder head seal including a layer of thermally expanded graphite, a PTFE coating being applied on at least one of the surfaces. The coating can be applied from a suspension, e.g. by spraying. The optimum thickness should be 5-20 micrometers. The PTFE coating proposed in this document is thus a layer of PTFE particles that are disposed next to one another and are so small that they can be placed in suspension.

A gasket formed of one or more graphite foils and in which at least one foil surface is partly coated with a substance that is present in the form of particles and reduces adhesive and sliding friction is known from the German Patent Application DE 24 41 602 by Sigri Elektrographit GmbH. Compounds having a layer lattice structure, such as molybdenum disulfide, boron nitride and graphite fluoride, temperature-resistant anti-adhesion polymers, such as PTFE and polyimide, and metal soaps and phthalocyanines, or mixtures of these substances, are described as suitable coating substances. The thickness of the substances formed of the lubricants should preferably be 5 to 200 μm. It is also described that the friction-reducing substances are applied as a dispersion. Preferably, the friction-reducing substances are rolled into the foil. As a result, for example, PTFE particles which are fixedly anchored in the foil surfaces and form island-like complexes are obtained.

Also known are composites including planar graphite foil layers and two-dimensionally contiguous plastics-containing layers, which adhere to the graphite foil layers.

For instance, European Patent DE 691 17 992 T2, corresponding to U.S. Pat. No. 4,961,991, describes a flexible graphite laminate intended to be suitable as a sealing element and in which a substance coated with polymer resin, e.g. PTFE, is inserted and bound between two lengths of flexible graphite material. In the flexible graphite laminate described in this document, the PTFE is thus located internally, between graphite layers.

German Patent Application DE 10 2012 202 748 A1 describes a method for manufacturing a graphite foil having a particularly low weight per unit area. In this case, graphite salt particles on a support are expanded to form graphite expandate in an expansion step. The graphite expandate remains on the support and is compressed on the support to form the graphite foil in a compression step. It is described that the graphite foil can form a laminate together with at least one plastics film. The plastics film can be formed of at least one of the plastics materials from the group including polyethylene terephthalate (PET), polyolefins, such as polyethylene (PE) and polypropylene (PP), polyvinyl chloride (PVC), polystyrene (PS), polyester, polyimide (PI), fluoroplastics, such as PVDF and PTFE, polycarbonate and biopolymers, such as polylactide (PLA), cellulose acetate (CA) and starch blends. It is also described that the graphite foil and plastics film can be interconnected without the use of adhesive. The plastics film can be perforated, with a hole diameter of between 0.25 and 2 mm being described. An application in sealing technology is also proposed.

Korean Patent KR 0158051 B1 relates to seals containing expanded graphite. It proposes impregnation with a sealing material such as PTFE, mentioning PTFE particles in particular. A PTFE film is also mentioned, without specifying a thickness.

PTFE foils and films are formed from PTFE blocks by removing a layer from the surface of the PTFE block using a planar cutting tool. It has been found that the layer has to adhere to a particular minimum thickness, otherwise foil production is not possible. The use of PTFE plastics films thus inevitably leads to certain high PTFE weights per unit area.

Utility Model G 92 08 943.7 U1 describes a gland seal having a plurality of graphite seal rings positioned one on top of the other to form a gland packing. At least one of the graphite seal rings has a graphite core and a jacket made of PTFE. The jacket can be shaped out of a PTFE foil or PTFE plate, or can be sintered onto the graphite core in a diffusion-tight manner. The PTFE jacket can be configured as a closed jacket or a furrowed jacket. There is no mention of a thickness of the PTFE jacket. The drawings show rather thick PTFE jackets. In the case of both the closed jacket and the furrowed jacket, two peripheral edges of the graphite core are covered with PTFE.

German Utility Model DE 21 2008 000 051 U1 relates to a seal for sealing a flange connection. It describes a core ring made of expandable graphite and coated with a coating layer of porous polytetrafluoroethylene. The coating layer is formed by winding a coating strip around the surface of the core ring in a spiral-like manner. The utility model also teaches that the windings of the coating strip should overlap. The coating strip thus entirely covers not only the two surfaces of the core ring, but also the inner and outer edge of the core ring. The coating strip can have a thickness of 0.045 to 0.25 mm, depending on the diameter of the core ring. It is described that the porosity of the coating strip can be, for example, 30 to 40% or 50 to 60%. The seals described in German Utility Model DE 21 2008 000 051 U1 are disadvantageous in that the thickness of the coating is always inconsistent since, during winding, regions having multiple overlaps and regions having just one overlap are always formed. In addition, the winding entails significant amounts of work and is difficult to automate.

### BRIEF SUMMARY OF THE INVENTION

It is accordingly an object of the invention to provide a layer composite for a seal and a method for manufacturing a layer composite, which overcome the hereinafore-mentioned disadvantages of the heretofore-known layer composites and methods of this general type and which provide a universally applicable sealing material that can be manufactured in a particularly simple and environmentally friendly manner and can be easily detached from the surfaces in contact with the sealing material even after long-term use at high pressure and high temperatures.

With the foregoing and other objects in view there is provided, in accordance with the invention, a layer composite for a seal, in particular for a gasket, comprising a planar substrate layer, e.g. a graphite foil layer, and a two-dimensionally contiguous polytetrafluoroethylene cover layer that adheres to a surface of the substrate layer, the polytetrafluoroethylene cover layer containing less than 200 g/m² polytetrafluoroethylene (PTFE). The cover layer thus contains less than 200 g PTFE per square meter of cover layer, generally at most 190 g/m² PTFE, in particular at most 175 g/m² PTFE, preferably at most 160 g/m² PTFE, more preferably at most 150 g/m² PTFE, particularly preferably at most 130 g/m² PTFE, especially preferably at most 110 g/m² PTFE, exceedingly preferably at most 100 g/m² PTFE, e.g. at most 80 g/m² PTFE.

Other features which are considered as characteristic for the invention are set forth in the appended claims.

Although the invention is described herein as embodied in a layer composite for a seal, a seal and a method for manufacturing a layer composite, it is nevertheless not intended to be limited to the details given, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DETAILED DESCRIPTION OF THE INVENTION

Referring now in detail to the invention, it is seen that the polytetrafluoroethylene cover layer is two-dimensionally contiguous. A two-dimensionally contiguous layer is understood to be a layer that, for example, can be two-dimensionally continuous (e.g. continuous in a gas-tight manner), can be porous or can have a mesh-like structure. However, a layer formed of particles positioned next to one another is not a two-dimensionally contiguous layer.

The feature “two-dimensionally contiguous” relates to the polytetrafluoroethylene. The two-dimensionally contiguous polytetrafluoroethylene cover layer is thus not, for example, a layer of polytetrafluoroethylene particles embedded in other substances, e.g. in other polymers, or pressed into the surface of the substrate layer, e.g. the graphite foil layer.

Surprisingly, it was found that layer composites according to the invention could be obtained in a particularly simple manner, in accordance with the method according to the invention described below, by using microporous polytetrafluoroethylene layers that are described, for example, in U.S. Pat. No. 3,962,153 and which will be discussed in more detail below in relation to the method according to the invention. By way of example, stretched polytetrafluoroethylene layers, which are known from many other different technical fields, e.g. GORE-TEX® membranes from the clothing industry, can be used. In that industry, however, these materials are used not for forming seals, but rather for forming layers for clothing that are permeable to water vapor and promote the wicking of water vapor away from the body in a targeted manner, in other words virtually “non-seals”. The use now being proposed thus contrasts with the main area of use of microporous PTFE layers known previously.

The layer composites according to the invention and the method according to the invention are environmentally friendly because only a very thin polytetrafluoroethylene cover layer having a very low weight per unit area of less than 200 g PTFE per square meter of cover layer is formed. PTFE-containing coatings were proposed in the prior art mentioned at the outset. Yet these are formed by means of suspensions or dispersions of PTFE particles. As a result, they are not two-dimensionally contiguous, but rather are formed substantially from PTFE particles positioned next to one another. Unlike the use, proposed according to the invention, of two-dimensionally contiguous microporous polytetrafluoroethylene cover layers, suspensions and dispersions containing PTFE particles pose a much higher risk of environment-damaging releases of PFTE, in particular during spraying. Since the PTFE particles are not interconnected, they are practically inseparable from the rest of the sealing material, which makes disposal more difficult. However, two-dimensionally contiguous PTFE can at least in large part be removed from the planar substrate layer in one piece. Compared with the PTFE foils mentioned in the prior art, there is the advantage of a lower weight per unit area; in other words, less PTFE is required overall, which increases environmentally compatibility.

The layer composite according to the invention is universally applicable, for instance over a very wide range up to particularly high pressures and temperatures. If PTFE layers having a relatively high weight per unit area are used at particularly high pressures and temperatures in gaskets in flanges, the contact pressure of the flange drops considerably over the service life, since substantial amounts of PTFE “creep out” of the seal. It has been found that the contact pressure of the flange remains high in the long term when gaskets comprising the layer composite according to the invention are used. Firstly, the particularly thin polytetrafluoroethylene cover layers appear overall to reduce the tendency of PTFE to creep. Secondly, the thickness of the gasket only drops to a minimal extent when the PTFE does creep since the low weight per unit area according to the invention means that there is only a very small amount of PTFE present anyway. Therefore, only a very small of amount of PTFE, if any, can “creep out” of the seal. As the PTFE “creeps out”, the thickness of the seal thus drops only very slightly and the contact pressure accordingly remains high. As a result, the maintenance required is reduced since screws on flanges need not be retightened, or need retightening less often, in order to maintain the desired contact pressure.

It has been found that gaskets according to the invention can be easily detached from the flange manually and without any visible residues even after 24 h at 300° C. and 30 MPa.

The layer composite includes a planar substrate layer. The planar substrate layer has two surfaces, which merge into one another in a peripheral edge region. The peripheral edge region defines the contour of the substrate layer.

The polytetrafluoroethylene cover layer adheres to a surface of the substrate layer. The polytetrafluoroethylene cover layer can extend into a region located outside the contour of the substrate layer. Typically, the polytetrafluoroethylene cover layer does not extend beyond this contour, or it extends beyond this contour only in one or more portions of the peripheral edge region. The length of the portion or portions in which the polytetrafluoroethylene cover layer extends beyond the contour is in total at most 99.9%, generally at most 90%, in particular at most 80%, preferably at most 70%, particularly preferably at most 60%, especially preferably at most 50%, e.g. at most 35% of the length of the peripheral edge region.

According to the invention, it is possible for the polytetrafluoroethylene cover layer to also extend around portions of the peripheral edge region of the substrate layer. In that case, the polytetrafluoroethylene cover layer regions covering the edge region also contribute to the total surface area of the polytetrafluoroethylene cover layer. According to the invention, however, it is preferable for more than 80%, in general more than 85%, preferably more than 95%, particularly preferably more than 98%, of the total surface area of the polytetrafluoroethylene cover layer to be located within the contour of the substrate layer. This is preferable since the total amount of PTFE required can thus be reduced further, which further improves the environmentally compatibility of the layer composite according to the invention.

Any planar material on the surface of which a microporous polytetrafluoroethylene layer can be applied by means of the method according to the invention can be used as the planar substrate layer. A person skilled in the art can easily test the suitability of a substrate layer. The planar substrate layer can, for example, be a graphite foil layer or a metal foil layer, the metal preferably being selected from stainless steel, nickel, nickel alloys, steel and copper, e.g. from stainless steel and nickel alloys.

Preferably, the planar substrate layer is a graphite foil layer.

The graphite foil layer is, for example, a graphite foil layer manufactured from expanded graphite. As is known, graphite foils can be manufactured by treating graphite with particular acids, thereby forming a graphite salt having acid anions incorporated between the graphene layers. The graphite salt is then expanded by exposing it to high temperatures of e.g. 800° C. The graphite expandate obtained during the expansion is then compressed to form the graphite foil. European Patent EP 1 120 378 B1, corresponding to U.S. Pat. No. 6,645,456 describes a method for manufacturing graphite foils. German Patent Application DE 10 2012 202 748 A1 mentioned in the introductory part also describes a method for manufacturing a graphite foil.

In the layer composite, the density of the graphite foil layer is generally 0.7 to 1.3 g/cm³, preferably 1.0 to 1.2 g/cm³, particularly preferably 1.0 to 1.1 g/cm³.

According to the invention, the polytetrafluoroethylene cover layer is located on the outside in the layer composite. This is the basis for the term “cover”. On the side of the polytetrafluoroethylene cover layer facing away from the planar substrate layer, therefore, no additional two-dimensionally contiguous material layer is applied. The microparticulate coating connected to the substrate layer by means of the polytetrafluoroethylene cover layer in accordance with particular embodiments of the invention is not an additional two-dimensionally contiguous material layer.

The polytetrafluoroethylene cover layer adheres to the surface of the substrate layer. What is meant by this is that the polytetrafluoroethylene cover layer is so rigidly connected to the surface of the substrate layer that the layer composite can be cut by water jet cutting or by punching without the layer composite separating. In general, the tensile strength of the connection between the two layers is greater than 1 N/mm², preferably greater than 2 N/mm². Surprisingly, it was found that microporous polytetrafluoroethylene layers can be applied very rigidly to planar substrate layers, and in particular to graphite foil layers, by pressing alone and/or by increasing the temperature. Presumably, microscopic irregularities in the substrate layer mesh with the micropores of the polytetrafluoroethylene layer during pressing and/or when the temperature is increased, and this guarantees an unexpectedly high adhesive strength on the substrate layer that goes far beyond technical requirements.

According to the invention, the polytetrafluoroethylene cover layer adheres to a surface of the planar substrate layer. In general, one of the two surfaces of the polytetrafluoroethylene cover layer is, in this case, in (almost) full contact with the surface of the substrate layer, e.g. at least 90% of one of the two surfaces of the polytetrafluoroethylene cover layer is in contact with the surface of the substrate layer.

In certain layer composites, for example in corrugated ring seals, the substrate layer is corrugated. Corrugated means that the substrate layer has wave extremes, i.e. maximums and minimums. One of the two surfaces of the polytetrafluoroethylene cover layer can be in almost full contact with one of the surfaces of the substrate layer. In that case, the surface abuts the surface of the substrate layer in the region of the maximums and in the region of the minimums, as well as in the regions located between the minimums and maximums. Preferably, portions of one of the two surfaces of the polytetrafluoroethylene cover layer are in contact with portions of one of the two surfaces of the corrugated substrate layer. By way of example, the contact between the substrate layer and the polytetrafluoroethylene cover layer only exists in the region of the maximums.

Polytetrafluoroethylene is a highly fluorinated polyethylene formed mostly, at least 85 wt. %, preferably at least 90 wt. %, particularly preferably at least 95 wt. %, for example at least 98 wt. %, of CF₂-CF₂ subunits. In polytetrafluoroethylene, the molar ratio of F atoms to H atoms is preferably more than 10, in particular more than 20, preferably more than 30.

The average thickness of the polytetrafluoroethylene cover layer is preferably in the range of 10 to 50 μm, in particular in the range of 10 to 40 μm, preferably in the range of 10 to 30 μm. In general, the cover layer contains 1 to 190 g/m² PTFE, in particular 2.5 to 175 g/m² PTFE, preferably 4 to 160 g/m² PTFE, more preferably 5 to 150 g/m² PTFE, particularly preferably 7 to 130 g/m² PTFE, especially preferably 9 to 110 g/m² PTFE, exceedingly preferably 10 to 100 g/m² PTFE, e.g. 12 to 80 g/m² PTFE.

The layer composite according to the invention is preferably 0.5 to 4.0 mm thick, particularly preferably 1.5 to 3.0 mm thick.

In one embodiment of the layer composite according to the invention, the polytetrafluoroethylene cover layer is uncoated on the surface facing away from the planar substrate layer. It was observed that, in that case, the polytetrafluoroethylene still adheres relatively strongly to the flange, even after relatively long use at high pressure and high temperature, and the composite formed of the polytetrafluoroethylene and substrate layer releases when the gasket is removed. Once the rest of the gasket is removed, however, the polytetrafluoroethylene can be fully detached from the flange without difficulty, without tools and substantially in one piece.

In another embodiment of the layer composite according to the invention, the polytetrafluoroethylene cover layer is coated on the surface facing away from the planar substrate layer. Any anti-adhesion coating that has been described in the prior art, in particular in relation to seals for flanges, is conceivable.

Preferably, the layer composite according to the invention has a microparticulate coating, which is connected to the substrate layer by means of the polytetrafluoroethylene cover layer.

The coating can fully or partly cover a polytetrafluoroethylene cover layer surface facing away from the substrate layer, for example by 5 to 99%, in particular by 10 to 98.5%, preferably by 20 to 98% particularly preferably by 25 to 97%, especially preferably by 30 to 95%.

The coating can include particles, e.g. graphite particles having an average particle size (d50) in the range of 1 to 50 μm, in particular in the range of 1 to 25 μm, e.g. in the range of 1 to 10 μm. The average particle size d50 describes a value that can be determined according to ISO 13320-2009 using laser granulometry and in which the cumulative distribution curve Q₃(X) of the particle size distribution is 50%.

Embodiments according to the invention including a microparticulate coating have the advantage of a further reduction in the adhesion of the polytetrafluoroethylene cover layer to the flange. As a result, gaskets including a microparticulate coating can be reliably detached from the flange in one piece, even after relatively long use at high pressure and high temperature. Detachment of delaminated PTFE from the flange at a later time is then not required. This provides the additional, crucial advantage that secure operation of the process can be particularly reliably guaranteed, even after seal replacement. This is because extensively or piecemeal adherent PTFE residues from old seals are easily overlooked, particularly on difficult-to-access flanges. PTFE residues lead to inconsistent contact pressure under newly inserted gaskets, which, in the worst-case scenario, can lead to uncontrolled leakage of hot fluids. Ultimately, therefore, the microparticulate coating means that, after a seal is replaced, particularly reliable operation of the process is guaranteed, even at high pressure and high temperatures, with even greater certainty than when using layer composites without a microparticulate coating.

In principle, the microparticulate coating can include a huge range of particles, e.g. silica flour, silicates, e.g. sheet silicates, mica, pigments, iron oxides, talc, metal oxide particles, e.g. Al₂O₃, SiO₂ and/or TiO₂.

Preferably, however, the microparticulate coating is a microparticulate solid-lubricant coating.

The solid-lubricant coating can include, for example, graphite particles, molybdenum disulfide particles and/or soft-metal particles, such as aluminum, copper or lead particles. Particularly preferred solid-lubricant coatings include graphite particles and/or molybdenum disulfide particles. An especially preferred solid-lubricant coating includes graphite particles.

Solid-lubricant coatings are advantageous in that, when they are applied, the porosity or residual porosity of the polytetrafluoroethylene cover layer generally does not increase. Solid-lubricant particles are soft and therefore the application thereof does not significantly impair the polytetrafluoroethylene cover layer. Generally, therefore, the application of the solid-lubricant coating does not lead to an undesirable amount of fluid permeability.

The layer composite is preferably fluid-tight, i.e. is substantially impermeable to gases and liquids. This can be determined in accordance with DIN EN 13555, for example.

Preferably, the layer composite according to the invention does not contain substances that form adhesive residues when heated to a temperature in the range of 100° C. to 400° C. and subsequently cooled to room temperature, or contains them only between fluid-tight layers. As a result, adhesive residues do not come into contact with the flange, and so a gasket produced from the layer composite can be separated from the flange at any time without difficulty.

Apart from the layers according to the invention mentioned above, the layer composite can have further layers, for example metal layers, preferably one or more sheet steel layers or stainless sheet steel layers, and/or further substrate layers, for example further graphite foil layers. The sheet metal layers can, for example, be plain sheet metal layers or rough sheet metal layers.

The layer composite according to the invention preferably includes a second two-dimensionally contiguous polytetrafluoroethylene cover layer. In that case, one polytetrafluoroethylene cover layer covers the layer composite on the front, and the second polytetrafluoroethylene cover layer covers the layer composite on the rear.

The above explanations regarding the two-dimensionally contiguous polytetrafluoroethylene cover layer apply accordingly to the second two-dimensionally contiguous polytetrafluoroethylene cover layer.

A second two-dimensionally contiguous polytetrafluoroethylene cover layer is particularly desirable when a gasket for a flange connection between pipe portions of a pipeline is made from the layer composite. In flange connections of pipe portions, both sides of the gasket are exposed to a similar extent to the fluid being conducted through the pipeline and to heat and pressure, and so the problem of the seal separating from the flanges of the two pipe portions likewise arises frequently. Even after 24 h at 300° C. and 30 MPa, layer composites according to the invention covered on both faces with a polytetrafluoroethylene cover layer can be separated from the two flanges without difficulty.

The second two-dimensionally contiguous polytetrafluoroethylene cover layer can also have a microparticulate coating. This coating is referred to as a second microparticulate coating. The above explanations regarding the microparticulate coating apply accordingly to the second microparticulate coating.

The two polytetrafluoroethylene cover layers can, for example, each adhere to one of the two surfaces of a planar substrate layer. By way of example, the two polytetrafluoroethylene cover layers adhere to the two surfaces of the graphite foil layer. In this embodiment, the layer composite includes one graphite foil layer and two two-dimensionally contiguous polytetrafluoroethylene cover layers, which adhere to the two surfaces of the graphite foil layer.

In a particularly preferred layer composite according to the invention, one polytetrafluoroethylene cover layer adheres to the surface of one planar substrate layer, e.g. the graphite foil layer, and the second polytetrafluoroethylene cover layer adheres to the surface of a second planar substrate layer, e.g. a second graphite foil layer. The two planar substrate layers can, for example, adhere to the surfaces of the planar substrate layers facing away from the polytetrafluoroethylene cover layers, on the two surfaces of a thin, e.g. 25 to 250 μm thick, planar metal layer, in particular a stainless sheet steel layer, e.g. a plain sheet metal layer or a rough sheet metal layer.

A layer composite according to the invention accordingly has the following layer structure:
polytetrafluoroethylene cover layer
planar substrate layer, e.g. graphite foil layer
planar metal layer
planar substrate layer, e.g. graphite foil layer
polytetrafluoroethylene cover layer.

Alternatively, one substrate layer adheres to the substrate layer surface facing away from the polytetrafluoroethylene cover layer, on a thin, e.g. 25 to 250 μm thick, metal layer, in particular a stainless sheet steel layer, e.g. a plain sheet metal layer, and the second substrate layer adheres to the surface of the second substrate layer facing away from the second polytetrafluoroethylene cover layer, on a further thin, e.g. 25 to 250 μm thick, metal layer, in particular a stainless sheet steel layer, e.g. a plain sheet metal layer. In that case, the two metal layers adhere to the surfaces of the two metal layers facing away from the polytetrafluoroethylene cover layers, on the opposing surfaces of a third planar substrate layer.

A layer composite according to the invention accordingly has the following layer structure:
polytetrafluoroethylene cover layer
planar substrate layer, e.g. graphite foil layer
planar metal layer
planar substrate layer, e.g. graphite foil layer
planar metal layer
planar substrate layer, e.g. graphite foil layer
polytetrafluoroethylene cover layer.

The layer composite according to the invention can contain further planar layers.

A further layer composite according to the invention has the following layer structure:
polytetrafluoroethylene cover layer
planar substrate layer, e.g. graphite foil layer
planar metal layer
planar substrate layer, e.g. graphite foil layer
planar metal layer
planar substrate layer, e.g. graphite foil layer
planar metal layer
planar substrate layer, e.g. graphite foil layer
polytetrafluoroethylene cover layer.

The applicant supplies a wide range of layer composites including graphite foil layers under the trademark Sigraflex®, e.g. also multi-layer composites having a plurality of layers of stainless steel foil and graphite foil. It goes without saying that layer composites according to the invention include all the layer composites already available under the trademark Sigraflex®, a polytetrafluoroethylene cover layer according to the invention being applied on at least one of the graphite foil surfaces or metal surfaces of these layer composites.

The present invention relates to a seal, in particular a gasket, including a layer composite according to the invention. However, the seal can also be a corrugated ring seal, a camprofile seal or a spiral-wound seal including the layer composite according to the invention.

It is particularly advantageous for gaskets in particular if the layer composite according to the invention has a certain flexural strength. It has been found that the composite can then be universally machined into large and small gaskets that can also be placed between flanges without difficulty, even overhead, without the sealing material flexing significantly or bending at all.

Particularly preferred layer composites according to the invention have a flexural strength (FS 3P) of at least 4.0 MPa, in particular at least 5.0 MPa, e.g. at least 5.5 MPa. The flexural strength is determined in accordance with ISO 178, as described below. Especially preferred layer composites according to the invention have a flexural strength of at least 6.0 MPa, e.g. more than 6.5 MPa. In that case, the layer composites are ideally suited for gaskets and can be placed between flanges particularly effectively, even overhead. On the other hand, they are then unsuitable for manufacturing gland seals since they can no longer be processed into a sealing yarn required for this purpose, or at least no longer by processing the layer composite into strips, twisting the strips and then braiding the twisted strips into a sealing yarn.

The gasket according to the invention can be cut out of the composite according to the invention, e.g. by punching or water-jet cutting.

With the objects of the invention in view, there is also provided a method for manufacturing a layer composite according to the invention, in which

a) a surface of a planar substrate layer, e.g. a graphite foil layer, is brought into contact with a microporous polytetrafluoroethylene layer, and
b) the polytetrafluoroethylene layer is pressed onto the surface of the substrate layer so strongly and/or the temperature is increased to such an extent that the polytetrafluoroethylene layer adheres to the substrate layer and a polytetrafluoroethylene cover layer adhered to the substrate layer is obtained.

The microporous polytetrafluoroethylene layer is a conventional porous and gas-permeable polytetrafluoroethylene membrane that is obtained by stretching polytetrafluoroethylene and used in clothing materials for the targeted wicking of water vapor away from the body. The manufacture of porous membranes of this kind is described, for example, in U.S. Pat. No. 3,962,153. The average pore size of the microporous polytetrafluoroethylene layer can vary over wide ranges, preferably in the range of 0.1 μm to 500 μm. The average pore size of the microporous polytetrafluoroethylene layer can be, for example, in the range of 0.1 μm to 10 μm.

It has been found that the polytetrafluoroethylene cover layer thus obtained still has a significant residual porosity. This residual porosity is lower than the porosity of the microporous polytetrafluoroethylene layer. Surprisingly, the gaskets made from the layer composite according to the invention still demonstrate very good sealing performance. The inventors have assumed that convex regions of the substrate layer protrude into the remaining pores in the polytetrafluoroethylene cover layer and that ultimately this crucially leads to the unexpectedly high sealing performance.

The pressure in step b) can be varied over wide ranges. For example, the polytetrafluoroethylene layer is pressed on at a pressure in the range of 0.2 to 10 N/mm², preferably at a pressure in the range of 0.4 to 5 N/mm². This provides the advantage whereby the pressure can be adjusted such that the substrate layer, e.g. the graphite foil layer, is compressed to a desired extent, i.e. up to a desired density.

The temperature in step b) can also be varied over wide ranges. For example, the temperature is increased to a range of 320 to 440° C. A person skilled in the art will select a higher temperature of up to 440° C. if there is only little time available to treat the substrate layer in contact with the microporous polytetrafluoroethylene layer. This is the case, for example, in a continuous method step b) if only a very short heating zone is available and if the substrate layer in contact with the microporous polytetrafluoroethylene layer needs to be guided through the heating zone very quickly. A person skilled in the art will select a lower temperature either of or just above 320° C. if there is a lot of time available to treat the substrate layer in contact with the microporous polytetrafluoroethylene layer. This is the case, for example, in a continuous method step b) if a very long heating zone is available and/or if the substrate layer in contact with the microporous polytetrafluoroethylene layer needs to be guided through the heating zone very slowly.

In a further method step c), a microparticulate coating can be applied on the polytetrafluoroethylene cover layer surface facing away from the substrate layer, the microparticulate coating being connected to the substrate layer by means of the polytetrafluoroethylene cover layer. Preferably, the connection between microparticles and the polytetrafluoroethylene cover layer is generated by sintering at 330 to 400° C. Preferably, the sintering is carried out at a temperature in the range of 350 to 410° C., e.g. 365 to 395° C. Any pores remaining in the polytetrafluoroethylene cover layer are closed either partly or fully during the sintering in the presence of the microparticles.

The invention also relates to the use of a microporous polytetrafluoroethylene for reducing the gas permeability of planar substrate layers.

The invention also relates to the use of a microporous polytetrafluoroethylene layer for forming a polytetrafluoroethylene cover layer that adheres to a surface of a graphite foil layer or metal foil layer.

The invention also relates to the use of a microporous polytetrafluoroethylene layer as a carrier for a microparticulate coating, e.g. a microparticulate solid-lubricant coating. Microparticulate solid-lubricant coatings were discussed in detail above.

In relation to this invention, the preferences set out above for the polytetrafluoroethylene cover layer apply to the weight per unit area of the microporous polytetrafluoroethylene layer. This is because over steps a) and b) the PTFE surface area barely changes, and so the initial weight per unit area of the microporous layer corresponds to the weight per unit area of the cover layer. The polytetrafluoroethylene layer thus contains less than 200 g PTFE per square meter of polytetrafluoroethylene layer. In general, the polytetrafluoroethylene layer contains 1 to 190 g/m² PTFE, in particular 2.5 to 175 g/m² PTFE, preferably 4 to 160 g/m² PTFE, more preferably 5 to 150 g/m² PTFE, particularly preferably 7 to 130 g/m² PTFE, especially preferably 9 to 110 g/m² PTFE, exceedingly preferably 10 to 100 g/m² PTFE, e.g. 12 to 80 g/m² PTFE.

Microporous polytetrafluoroethylene layers having completely different thicknesses can be used. For example, at a given weight per unit area, very porous polytetrafluoroethylene layers are thicker than less porous polytetrafluoroethylene layers. Typically, the thickness of the microporous polytetrafluoroethylene layer is in a range of 25 to 400 μm.

The roughness of the surface of the planar substrate layer is preferably Rz 1.5 μm to Rz 30 μm, e.g. Rz 3 μm to Rz 15 μm. It has been assumed that convex regions of the surface of the substrate layer mesh with pores of the microporous polytetrafluoroethylene layer and the application of pressure and/or the increase in the temperature in step b) intensifies the meshing, which increases the adhesion of the polytetrafluoroethylene layer on the surface. A person skilled in the art can adjust the roughness of a substrate layer, e.g. of a graphite foil layer, by treating the graphite foil with a textured roller.

The planar substrate layer is preferably compressible. The compressibility of the planar substrate layer is preferably 5 to 80%, e.g. 20 to 60%. If the substrate layer yields when pressure is applied in step b), the meshing appears to be intensify, and so, particularly with compressible planar substrate layers, the application of pressure in step b) leads to strong adhesion of the polytetrafluoroethylene cover layer on the planar substrate layer.

Further advantages and preferences of the invention will become apparent from the following example embodiment.

### EXAMPLE

Graphite foil was coated with an ePTFE membrane (thickness approximately 100 μm) at room temperature by means of a calender. The ePTFE membrane used was a conventional porous, gas-permeable, white polytetrafluoroethylene membrane obtainable by stretching polytetrafluoroethylene. Next, temperature treatment was carried out at 380° C., during which a colourless, glass-like polytetrafluoroethylene cover layer (thickness: approximately 20 μm) was formed on the graphite foil and rigidly adhered to the graphite foil.

In one experiment, the layer composite obtained from the calender was coated with graphite powder (particle size 2-10 μm) before the temperature treatment. In the process, the graphite particles penetrated open pores in the ePTFE membrane in part. In the subsequent temperature treatment, the graphite particles were fused into the surrounding polytetrafluoroethylene and thus immobilised particularly rigidly. An anti-adhesion coating was thus produced.

### Flexural Strength:

The flexural strength (FS 3p) was determined using a three-point bending test, in which the test sample was positioned on two supports in accordance with ISO 178 and loaded in the centre using a test mandrel.

The layers and layer composites tested for flexural strength:

L1: Graphite foil, 1.3 mm thick, density of 0.7 g/cm³
L2: Graphite foil L1, coated on one side with an ePTFE cover layer
L3: ePTFE cover layer—graphite foil L1—rough metal sheet, 80 μm thick—graphite foil L1—ePTFE cover layer. The two outer ePTFE cover layers in the layer composite were additionally surface-coated with microparticulate graphite powder
L4: Graphite foil L1—rough metal sheet, 100 μm thick—graphite foil L1

Four or five material samples of each layer or layer composite were tested for flexural strength. The results are shown in the table below:

| | Sam- | Sam- | Sam- | Sam- | Sam- | Av- |
|---|---|---|---|---|---|---|
| | ple 1 | ple 2 | ple 3 | ple 4 | ple 5 | erage |
| | [MPa] | [MPa] | [MPa] | [MPa] | [MPa] | [MPa] |
| L1 (FS | 5.2 | 5.1 | 5.2 | 5.2 | | 5.2 |
| 3 p) | | | | | | |
| L2 (FS | 6.1 | 6.1 | 5.9 | 5.9 | | 6.0 |
| 3 p) | | | | | | |
| L3 (FS | 7.1 | 6.8 | 6.8 | 6.8 | 6.7 | 6.8 |
| 3 p) | | | | | | |
| L4 (FS | 6.9 | 7.3 | 7.0 | 7.7 | | 7.2 |
| 3 p) | | | | | | |

1. A layer composite for a seal, the layer composite comprising:
a planar substrate layer having a surface; and
a two-dimensionally contiguous polytetrafluoroethylene cover layer adhering to said surface of said planar substrate layer;
said polytetrafluoroethylene cover layer containing less than 200 g/m² of polytetrafluoroethylene.

2. The layer composite according to claim 1, wherein said polytetrafluoroethylene cover layer has an average thickness in a range of 10 to 50 μm.

3. The layer composite according to claim 1, wherein:
said polytetrafluoroethylene cover layer has a surface facing away from said planar substrate layer;
a microparticulate coating is connected to said planar substrate layer by said polytetrafluoroethylene cover layer; and
said microparticulate coating at least partly covers said surface of said polytetrafluoroethylene cover layer facing away from said planar substrate layer.

4. The layer composite according to claim 3, wherein said microparticulate coating includes particles having an average particle size in a range of 1 to 50 μm.

5. The layer composite according to claim 3, wherein said microparticulate coating is a microparticulate solid-lubricant coating.

6. The layer composite according to claim 1, wherein the layer composite does not contain substances forming adhesive residues when heated to a temperature in a range of 100° C. to 400° C. and subsequently cooled to room temperature, or only contains the substances between fluid-tight layers.

7. The layer composite according to claim 1, wherein said planar substrate layer is a graphite foil layer.

8. A seal, comprising a layer composite according to claim 1.

9. A method for manufacturing a layer composite according to claim 1, the method comprising:
a) bringing a surface of a planar substrate layer into contact with a microporous polytetrafluoroethylene layer; and
b) at least one of pressing the polytetrafluoroethylene layer onto a surface of the planar substrate layer so strongly or increasing a temperature to such an extent that the polytetrafluoroethylene layer adheres to the substrate layer and a polytetrafluoroethylene cover layer adhered to the substrate layer is obtained.

10. The method according to claim 9, which further comprises, in step b), at least one of pressing-on the polytetrafluoroethylene layer at a pressure in a range of 0.2 to 10 N/mm² or increasing the temperature to a range of 320 to 440° C.

11. The method according to claim 9, which further comprises:
c) applying a microparticulate coating on a surface of the polytetrafluoroethylene cover layer facing away from the planar substrate layer, and using the polytetrafluoroethylene cover layer to connect the microparticulate coating to the substrate layer.

12. The method according to claim 11, which further comprises producing the connection between microparticles and the polytetrafluoroethylene cover layer by sintering at 330 to 400° C.

13. A planar substrate layer, comprising a microporous polytetrafluoroethylene layer containing less than 200 g/m² of polytetrafluoroethylene, for reducing a gas permeability of the planar substrate layer.

14. A polytetrafluoroethylene cover layer, comprising a microporous polytetrafluoroethylene layer containing less than 200 g/m² of polytetrafluoroethylene, causing the polytetrafluoroethylene cover layer to adhere to a surface of a graphite foil layer or metal foil layer.

15. A carrier, comprising a microporous polytetrafluoroethylene layer containing less than 200 g/m² of polytetrafluoroethylene, allowing the carrier to be used for a microparticulate coating or a microparticulate solid-lubricant coating.
